(19) United States
(12) Patent Application Publication
(10) Pub. No.: US 2006/0085292 A1
(43) Pub. Date: Apr. 20, 2006

(54) Systems and methods for managing alcoholic beverages

(76) Inventor: Thierry Lafay, Quincie (FR)

Correspondence Address: OLIFF & BERRIDGE, PLC, P.O. BOX 19928, ALEXANDRIA, VA, 22320, US

(21) Appl. No.: 10/909,427

(22) Filed: Aug. 3, 2004

(51) Int. Cl. G06Q 99/00

(52) U.S. Cl. 705/28; 705/1

(57) ABSTRACT

A systems and methods for managing alcoholic beverages, including separate operating levels. A first operating level, accessible to experts, includes a first database in which alcoholic beverage knowledge, including their respective service protocols, are indexed and stored and a first set of instructions for running the first database and communicating the first database with a network. A second operating level, accessible to managers, includes a second database in which data specific to at least one retail outlet is stored; and a second set of instructions for running the second database and exchanging information with the first database, in order to issue an alcoholic beverage list with at least a portion of the knowledge on the first database and at least a portion of the data on the second database specific to respective alcoholic beverages on the alcoholic beverage list, and make the alcoholic beverage list available to the network. A third operating level, accessible to alcoholic beverage servers, includes a third set of instructions for exchanging information with the second database, so as to display the at least a portion of the knowledge on the first database and the at least a portion of the data on the second database specific to the respective alcoholic beverages on the alcoholic beverage list, and to report to the second operating level information specific to retailing.

### BACKGROUND OF THE INVENTION

1. Field of Invention

The present invention relates to systems and methods for managing the distribution, administration, service, and/or retail of various alcoholic beverages, based on the expertise or knowledge related to the various alcoholic beverages.

2. Description of Related Art

With respect to wines, there is presently a substantial lack of skill for wine distribution, administration, service, and/or retail at service and retail establishments, for example, a wine shop or restaurant. At the same time, the worldwide demand for fine wine is growing.

Conventionally, it has been difficult and time consuming for managers to maintain accurate and up to date alcoholic beverage inventory records. As a result, some of the alcoholic beverages may age beyond their preferred aging period, or even spoil. Also, conventionally there has been a high turnover rate among alcoholic beverage servers. Accordingly, it is becomes expensive and time consuming to train replacement alcoholic beverage servers with the proper level of alcoholic beverage service knowledge.

Thus, some alcoholic beverage establishments hire experts, e.g., sommeliers, to maintain alcoholic beverage inventory and train alcoholic beverage servers. However, the hiring of experts is inefficient and cost prohibitive for the majority of alcoholic beverage retailers due to the small number of individual experts and the high compensation required to employ them.

### SUMMARY OF THE INVENTION

Thus, there is a need for efficient and cost effective interconnection between alcoholic beverage managers, such as restaurant managers that are responsible for the administration of alcoholic beverage retail and service as well as setting up and providing information about how alcoholic beverage should be sold and/or served in a restaurant and/or shop; alcoholic beverage experts, such as sommeliers and wine experts that possess expertise and knowledge about alcoholic beverages; and alcoholic beverage servers, such as waiters, bartenders and retailers, who follow management directives and receive instructions on alcoholic beverage service, and who report about customer activity at service and/or retail establishments. As used herein, the term “server” is intended to encompass anyone who interacts with a customer to dispense alcoholic beverages in a retail environment including, for example, waiters, bartenders, and/or retail assistants. Furthermore, as used herein, the term “retail” is intended to encompass all environments in which alcoholic beverages are available to the public for sale and/or consumption including, for example, restaurants, bars, specialty shops, and/or general shops (e.g., grocery stores).

Accordingly, various exemplary embodiments of this invention provide systems and methods for managing alcoholic beverages that provide precise and complete data about alcoholic beverage inventory, for example, in units and value, with predicted appreciation/depreciation rates.

Various exemplary embodiments of the invention maintain expertise at the level of the alcoholic beverage manager. Thus, even if a rapid turnover of alcoholic beverage servers exists, there would be no substantial training expenditure cost or required for replacement alcoholic beverage servers.

Various exemplary embodiments of the invention provide knowledge to the level of the alcoholic beverage manager by providing access to alcoholic beverage experts' knowledge.

Various exemplary embodiments of the invention improve and speed up alcoholic beverage dispensers training about alcoholic beverage and alcoholic beverage retail and service.

Various exemplary embodiments of the invention determine an accurate data regarding the ageing of various alcoholic beverages such that the alcoholic beverages may be served at their maturity but prior to spoilage.

Thus, various exemplary embodiments of the invention provide a method for managing alcoholic beverages, including collecting, at a first operating level, knowledge from experts about a plurality of alcoholic beverages, including their respective service protocols; storing, at the first operating level, the collected knowledge into a first memory; collecting, at a second operating level, information from a manager including data specific to at least one retail outlet; storing, at a second operating level, the collected information into a second memory; exchanging, at the second operating level, information with the first operating level; issuing, at the second operating level, at least one alcoholic beverage list with at least part of the collected knowledge and at least part of the collected information, each of the at least part of the collected knowledge and the at least part of the collected information respectively specific to various alcoholic beverages on the alcoholic beverage list; retailing, at a third operating level, at least one of the various alcoholic beverages on the alcoholic beverage list; exchanging, at the third operating level, information with the second operating level; displaying, at the third operating level, based on the information exchanged with the second operating level, at least part of the at least part of the collected knowledge and at least part of the at least part of the collected information; and reporting at the third operating level, information related to the retailing of the at least one of the various alcoholic beverages on the alcoholic beverage list.

Various exemplary embodiments of the invention provide an alcoholic beverage management system, including a first operating level, hosted on a networked server, accessible to experts, including a first database in which alcoholic beverage knowledge, including their respective services protocols, are indexed and stored; and a first set of instructions for running the first database and communicating the first database with a network. The system includes a second operating level, hosted on an networked server, accessible to managers, including a second database in which data specific to at least one retail outlet is stored; and a second set of instructions for running the second database and exchanging information with the first database, in order to issue an alcoholic beverage list with at least a portion of the knowledge on the first database and at least a portion of the data on the second database specific to respective alcoholic beverages on the alcoholic beverage list, and make the alcoholic beverage list available to the network. The system further includes a third operating level, hosted by a networked console, accessible to alcoholic beverage servers, including a third set of instructions for exchanging information with the second database, so as to display the at least a portion of the knowledge on the first database and the at least a portion of the data on the second database specific to the respective alcoholic beverages on the alcoholic beverage list, and to report to the second operating level information specific to retailing.

Various exemplary embodiments of the invention provide a method for managing alcoholic beverages, including collecting knowledge from experts about a plurality of alcoholic beverages, including their respective service protocols; storing, the collected knowledge into a memory; and providing the stored knowledge to at least one retail outlet, to be used to issue at least one alcoholic beverage list; wherein the collected knowledge is stored as elementary concepts, the elementary concepts specifically tailored to be easily assembled to create the at least one alcoholic beverage list, and the at least one alcoholic beverage list includes at least a part of the collected knowledge.

Various exemplary embodiments of the invention provide a method for managing alcoholic beverages, including collecting information from a manager including data specific to at least one retail outlet; storing the collected information into a memory; exchanging information with an electronic alcoholic beverage knowledge repository that is remote from the memory, the electronic alcoholic beverage knowledge repository storing elementary concepts specifically tailored to be easily assembled to create the at least one alcoholic beverage list; and issuing, at least one alcoholic beverage list with at least part of the collected information and at least one elementary concept from the electronic alcoholic beverage knowledge repository.

Various exemplary embodiments of the invention provide a method for managing alcoholic beverages, including retailing at least one alcoholic beverage on an alcoholic beverage list, the alcoholic beverage list including information from a manager including data specific to at least one retail outlet and at least one elementary concept specifically tailored to be easily assembled to create the at least one alcoholic beverage list, the at least one elementary concept obtained from a remote electronic alcoholic beverage knowledge repository; exchanging information with a managing knowledge repository; displaying, based on the information exchanged with the managing knowledge repository, at least part of the alcoholic beverage list; and reporting to the managing knowledge repository information related to the retailing of the at least one alcoholic beverage on the alcoholic beverage list.

### BRIEF DESCRIPTION OF THE DRAWINGS

Exemplary embodiments of the invention will now be described with reference to the accompanying drawings, wherein:

FIGS. 1 and 2 represent a general work flow of a systems and methods for managing wines in restaurants;

FIG. 3 diagrammatically represents the main processes and data exchanges between the main domains of a management system according to exemplary embodiment of the invention;

FIG. 4 shows an exemplary data structure of a restaurant database VSRDB;

FIG. 5 shows an exemplary data structure of the data stored locally on the console VSC;

FIG. 6 shows an exemplary display format on the console VSC for describing the wine;

FIG. 7 shows an exemplary display format on the same console for instructing the waiter how to serve the wine;

FIG. 8 shows an exemplary manager main interface of the second operating level;

FIG. 9 shows an exemplary manager interface at the second level for wine description and bar code generation;

FIG. 10 shows an exemplary manager interface at the second level for instructions to the staff;

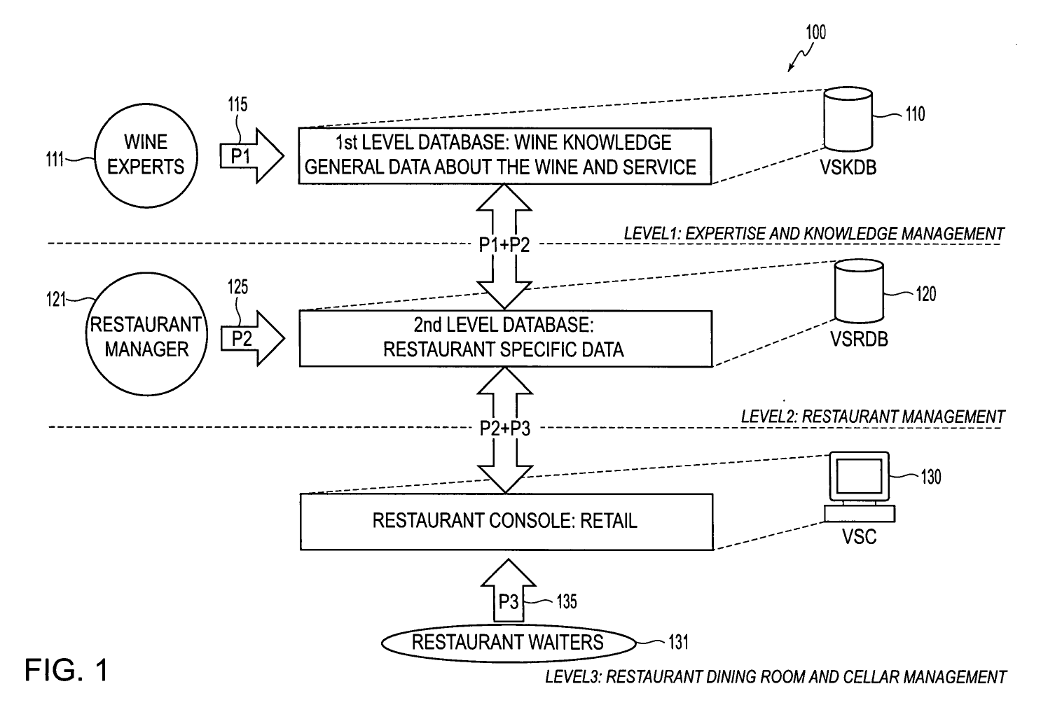

FIG. 1 shows an exemplary manager interface at the second level for service protocol tuning;

FIG. 12 shows an exemplary manager interface at the second level for cellar management;

FIGS. 13 and 14 show exemplary interfaces which are available to the wine expert at the first operating level;

FIG. 15 describes an exemplary process implemented by the Restaurant Manager at the second operating level referenced as Proc 3-A;

FIG. 16 describes an exemplary process implemented by the Restaurant Manager at the second operating level referenced as Proc 3-C;

FIG. 17 describes an exemplary process implemented by the Restaurant Manager at the second operating level referenced as Proc 3-B;

FIG. 18 describes the way how the data are synchronized between the console VSC and the restaurant database VSRDB;

FIG. 19 describes an exemplary main program implemented by the console VSC;

FIG. 20 shows in schematic manner the change in quality of a wine;

FIG. 21 shows the change in quality for various wines; and

FIG. 22 shows how to determine at a time (t) the level of quality of two different wines (A) and (B).

### DETAILED DESCRIPTION OF PREFERRED EMBODIMENTS

An exemplary embodiment of the invention will now be defined and described in the context of a wine management system and method, applied to restaurants. It should be appreciated that the principles described below can be extended to alcoholic beverage other than wines, as well as to organizations other than restaurants. Furthermore, it should be appreciated that one or more of the principles or elements described below may be combined, separated, duplicated, or omitted, as needed, based on cost and/or resource considerations.

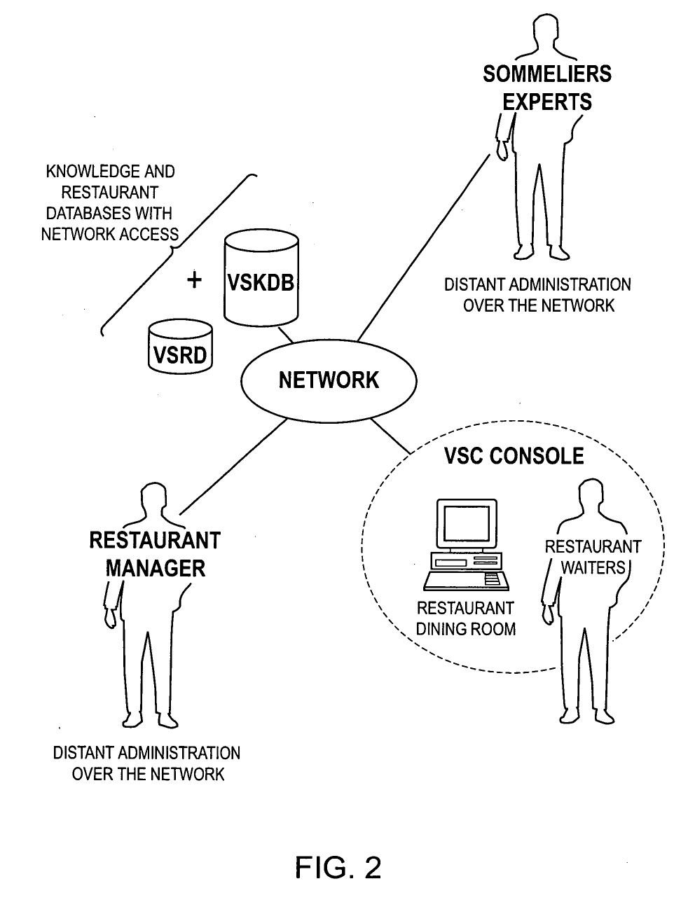

FIGS. 1 and 2 show a system 100 and method for sharing knowledge in the alcoholic beverage art and communicating alcoholic beverage managers 121 with alcoholic beverage experts 111 and alcoholic beverage servers 131. As shown in FIG. 1, at a first operating level, alcoholic beverage knowledge about various individual alcoholic beverages, including their respective services, may be collected from alcoholic beverage experts 111. The collected knowledge and data may be stored, for example, into a first database (VSKDB 110) hosted on a server. The alcoholic beverage experts 111 may interface with the VSKDB 110 via, for example, a client computer communicating with the server through a program P1. The program P1 which runs, for example, on the server hosting the VSKDB 110, is dedicated to manage the VSKDB 110 and is capable of collecting information from the alcoholic beverage experts 111, store the collected information, index the stored information, and make the information available to other databases (VSRDB 120) and/or consoles (VSC 130).

At a second operating level of alcoholic beverage management, shown in FIG. 1, manager information comprising data specific to at least one retail and/or service outlet, is collected and stored into, for example, a second database (VSRDB 120) hosted on a server. The alcoholic beverage managers 121 may interface with the VSRDB 120 via, for example, a client computer communicating with the server through a program P2. The program P2 which runs, for example, on the server hosting the VSRDB 120 stores and manages alcoholic beverage data relative to specific retail and/or service outlets. The server hosting the VSRDB 120 is connected to the server hosting the VSKDB 110, for example, over a network such that the second operating level may exchange information with the first operating level, so as to obtain and utilize at least an alcoholic beverage list with knowledge and data respectively specific to the alcoholic beverage on the obtained list

At a third operating level of alcoholic beverage service and/or retail, shown in FIG. 1, information is exchanged with the second level and provided to alcoholic beverage servers 131 via, for example, a console (VSC 130). The VSC 130 runs a program P3 that is capable of exchanging information with the server hosting the VSRDB 120. The program P3 may display, knowledge and data in relation to the respective alcoholic beverage of the alcoholic beverage list provided by the VSRDB 120. The program P3, in return, reports to the second operating level information specific to the service and/or retail outlet.

According to this exemplary embodiment of the invention, the knowledge and/or data collected from experts 111 comprises information related to, for example, appellations and/or service protocols, wine ageing, for instance ageing curves, academic knowledge about wine, testing notes or quotations, and/or vintage charts.

The information collected and stored from an alcoholic beverage manager 121 includes, for example, data regarding the alcoholic beverage inventory report and cellar activity. The knowledge and data displayed at the service outlet and/or retail includes, for example, management directives, and/or instructions on wine service and presentation. Information specific to the service and/or retail outlet that may be transmitted to the VSRDB 120 includes, for example, data related to the cellar activity.

Furthermore, there may be working instructions, and/or service protocols for the alcoholic beverages respectively, and/or general service instructions obtained and issued at the second operating level.

Thus, applied to wine management and as shown in FIGS. 1 and 2, the above-described exemplary embodiment of the invention links at least three different participating actors, for instance by distant administration over a network, such as, for example, over the Internet through standard web browser. The various actors include experts 111 (sommeliers, etc.) who possess the knowledge and expertise about wines, a wine or restaurant manager 121 who manages the inventory of the wines, and their distribution, i.e., in retail and/or service, and at least a restaurant waiter 131, in the restaurant dining room who, for example, serves the wine to consumers. The duties of these actors can be described as follows.

The restaurant manager 121 is responsible for making key decisions regarding which wines to serve in the restaurant and how to serve them. His prospective may be based on management considerations intended to maximize business objectives such as assets, turnover, employee training and skills development, customer service, and financials ratio (margin, return on investment).

According to this exemplary embodiment, the key decisions and assignments of the manager 121 include maintaining and editing a list of wines to serve in the restaurant, for example, the restaurant list may be sorted by countries and appellations. A short list of wines may be available by the glass and another short list may be available in small bottles. The restaurant manager's 121 decisions and assignments may also include the daily staff brief. The daily staff brief can include a list of reminders regarding what to do before, during and after the service, instructions on which wines to suggest with the specials of the day, instructions on which wines to promote (for example, for inventory reduction purpose), instructions on how to prepare wines prior to the service (6 bottles of a certain wine in refrigerator A, 12 bottles of a certain wine in refrigerator B, etc., 2 bottles of Chateau X decanted at 6:00 pm).

The restaurant manager's 121 decisions and assignments may further include teaching and supervising service protocols. Service protocols are simple processes combining step by step tasks to manage the cellar, prepare the wines for service, and handle customer relations. The same protocol may be applied to several wines. For example, the “light rosés service protocol” would combine the following elementary steps:

1. Prepare an ice bucket half filled with water and ice plus one towel;

2. Get the bottle from the cellar immediately after order;

3. Open the bottle and put the cork in ice bucket (refreshing);

4. Keep the bottle refreshing for 3 minutes;

5. Bring the ice bucket plus the bottle to the table;

6. Give the customer the wine presentation (brief version) and pour for testing;

7. Get customer approval;

8. Pour remaining guests half a glass;

9. Salutation: “The rest will keep fresh in the ice bucket. I will be back soon, enjoy your wine.”

The restaurant manager's 121 decisions and assignments may further include providing service instructions. Each service instruction, for example, tells a server 131 what to do when a wine is ordered by a customer, e.g., where to find it in the cellar, how to carry it from the cellar to the dining room, how to prepare the wine, how to serve it at the table, and what to say to the customer about this wine. These service instructions may be specific to each wine and may further include detailed quantitative and qualitative information such as service temperature, proper glass to use, level to fill in the glass, food and wine pairing advice, and wine description (appellation, producer, wine making technique, tasting notes, etc.).

The restaurant waiter 131 (server) is responsible for maximizing the customer's wine enjoyment. The responsibilities of the waiter 131 include serving the wine (including bottle preparation) as well as helping the customer to make his wine selection. In addition to pouring the wine, the waiter 131 should entertain the guests with informative and relevant information about the wine they are about to taste. It should be appreciated that the waiter 131 need not be “a sommelier” in knowledge and responsibility. He is not responsible for making detailed and informed decisions regarding the wine. He is just following instructions of his management reflecting the restaurant's wine policy. His wine knowledge is basic. The various exemplary embodiments of the invention provide a guide for him and a tool to get instructions and handle day to day service situations in the restaurant in a manner in which it will appear that he/she is very knowledgeable about wine.

Conversely, the wine experts 111 are highly focused on certain sides of wine. They help to build the Wine Knowledge Database (VSKDB 110), to structure it and to populate it with relevant data to be used by the restaurant manager 121 to customize a restaurant database 120. Sommeliers have extensive experience in serving wine and wine cellar management in the restaurant business. They provide the VSKDB 110 information derived from their own experience of certain wines, different kinds of customers, and different types of cuisine.

Wine consultants, on the other hand, focus on the various wine producing areas (e.g., Bordeaux, Burgundy, New Zealand, Oregon, Chile, etc.) They may prepare “information packages” that may be, for example, stored within the VSKDB 110 to be adapted by the restaurant manager 121 for his wine descriptions. Although wine consultants and sommeliers differ by nature, for the purpose of this exemplary embodiment, they are each considered “experts” 111.

The system administrator can be one person or a team of persons, for example, providing technical support to manage and to maintain hardware and software devices. They prepare all technical aspects of the, for example, various operating systems, servers, and terminals, and help the previously-described actors to customize them and to use them on a daily basis. The system administrator's typical responsibilities include, for example, setting up databases for the restaurant (e.g., VSRDB 120) and the for the experts 111 (VSKDB 110), setting up login accounts for users with appropriate access to manage information, backup and restoring operations of databases, and tech support.

The hardware and software architecture of a wine management system according to the present exemplary embodiment of the invention will be explained with reference to FIGS. 1-3.

As discussed above, with reference to FIGS. 1 and 2, the exemplary system is based on three main domains: the VSKDB 110 (Wine Knowledge Database), the VSRDB 120 (Restaurant Database), and the VSC 130 (Virtual Sommelier Console). Various processes may be run by three different programs hosted on the servers (P1 and P2) and on the VSC 130 (P3).

The VSC 130 can include, for example, a central unit (hardware) based on, for example, a standard PC or any other similar system with an operating system (e.g., Windows®, Mac OS®, Linux®, etc.); a monitor to display information for dispensers (hardware); and a bar-code scanner or similar device (hardware) and its appropriate driver to, for example, read bar-codes and identify the wines. The bar-code is just one example of technology that may be used to identify the various wines. Any other technology such as, for example, radio tags that link a physical signal to a code to be processed by a computer may also be used.

The VSC 130 can include, for example, a graphic user interface implemented in any programming language (e.g., Java®, C++, HTML, etc.). A Data Synchronization Module may control the synchronization of data between the VSRDB 120 and the VSC 130. The data synchronization module can include, for example, a specific program and a hardware connection device to a network such as, for example, a dial-up modem or any LAN connection.

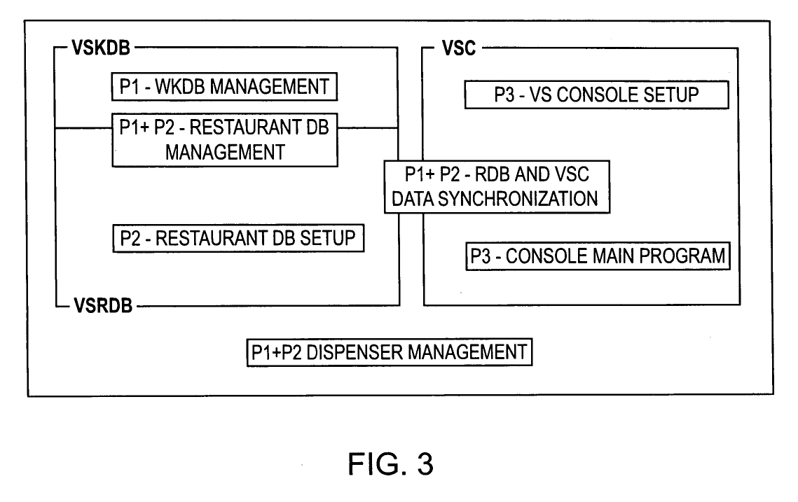

Thus the VSC 130 can include software components such as data files, a data synchronization module, a graphic user interface, and a main program as well as hardware components such as a central unit, a monitor, a bar-code scanner (or equivalent device) and a connection device. The chart shown on FIG. 3 shows the above-described information managemnt arrangement.

The VSRDB 120 is originally set up by the administrator. The restaurant manager then implements the VSRDB 120 according to his strategy for restaurant management, for example, he can use it to simply send wine descriptions to the VSC 130. Alternatively, he can also use many complex options to improve the wine service management.

The VSRDB 120 is accessible via a network, for example, online through a standard web browser and a valid access login. The VSRDB 120 provides a functional framework to prepare data for the VSC 130. The VSRDB 120 can prepare and provide activity reports so that the Manager can track wine activity for his restaurant. The VSRDB 120 can remotely control the experts 111 advices on the VSKDB 110 to be used in preparing tasting notes, service protocols, and wine presentations.

The data stored on the VSRDB 120 may be gathered and put into ready to download files by the program P2. Furthermore, the VSRDB 120 is capable of synchronizing with the VSC 130, wherein files are transferred by the Data Synchronization Module from the third program P3 to the VSC 130.

According to this exemplary embodiment, the Wine Knowledge Database (VSKDB110) is the database used by experts 111 to make their knowledge available to restaurant managers 121. The VSKDB 110 may be considered, for example, a collaborative framework where knowledge and expertise is stored, broken down, organized and formatted in, for example, ready to use packages. The organization makes it easy for a restaurant manager to pickup and gather different sources of information in a useful manner to write informative descriptions of the wines served in his restaurant and/or to structure the wine service protocols.

The VSKDB 110 may include, among other things, information related to appellations. Such information could include, for example, list of official appellations used for wine classification. Old producing countries like France, Spain and Italy use complex classification of wines with law enforced regulation regarding wine production and precise designations. Other countries, like USA, Australia, New Zealand, are developing their own systems. The VSKDB 110 may reference all official appellations and explain the different terms used to qualify the wine in its corresponding classification system.

The VSKDB 110 may also include various ratings such as critics' quotations. Some famous wine critics are very influential on customers choice. Being able to quote an critic while presenting a wine is highly valuable for a waiter. Thus, the VSKDB 110 may be populated with accurate quotations classified according different criteria. The restaurant manager can then pick quotations, download them to the VSRDB 120, and link them to some of his wines. The linked quotation will then be accessible on the VSC 130 when a waiter consults the VSC 130 before serving a wine. Accordingly, the waiter will be able to quote the critic and impress the customer.

The VSKDB 110 may also include “Elementary Concepts.” The Elementary Concept (ECn) is a basic idea or a simple concept to encapsulate wine expertise into conceptual units that are easy to approach, to understand, and to explain. They are the elementary bricks of wine knowledge that the manager 121 will combine to write useful information and comments for the wine service.

For example, if a manager 121 wanted to compile information about the rosés wines produced in Tavel, the manager 121 would, for example, use the following three basic ideas:

1. Tavel is the name of a small Village (EC1) located in the Southern Rhone Valley in France;

2. Tavel rosés are produced as “Rosés de Saignée” (EC2), which is a specific wine making technique. Full grapes are kept in contact with juice to extract color and other wine components before pressing. This technique makes rosés taste much finer with fresher aromatic notes.

3. Tavel rosés are full bodied. Much more that other rosés (EC3) and pair generally well with medium to strongly spiced food.

Each of these basic ideas may be, for example, stored in the database as Elementary Concepts referenced by keywords making the database easy to browse. Accordingly, when a restaurant manager 121 writes his notes for a Tavel wines of his wine list, the manager 121 can search in the VSKDB 110 with the keyword “Tavel” The search result would return among other Elementary Concepts the previous three Elementary concepts related to relevant information about Tavel. The restaurant manager 121 can use each of these Elementary Concepts as written or adapt it to his wine description.

The VSKDB 110 may also include “Service Protocols.” Service Protocols are simple tasks to be executed step by step to prepare and serve a wine. A task is one operational step such as, for example, “put in ice bucket”, “wash the carafe with clean water”, or “pour one ounce” According to this exemplary embodiment, service protocol models may be predefined so that a restaurant manager can start from a standard protocol model and adapt it easily for the specific wine service in his restaurant.

The VSKDB 110 may also include vintage charts. Many wine critics rate a vintage for certain wine categories. According to the vintage charts, some vintages are considered better than others. This information can help the restaurant manager 121 to select his inventory and price his wines. Also, it helps the restaurant waiter 131 to answer a customer when consulted about a particular vintage in the wine list.

The VSKDB 110 may include ageing curves. Depending on the wine type and the wine making technique(s), wines evolve differently with time. This information is critical when a manager 121 considers cellar management and serving priority. The ageing curves are, for example, designed by enologists for each type of wine and vintages in general. The restaurant managers 121 can thus refer to them for purchasing decisions and cellar management.

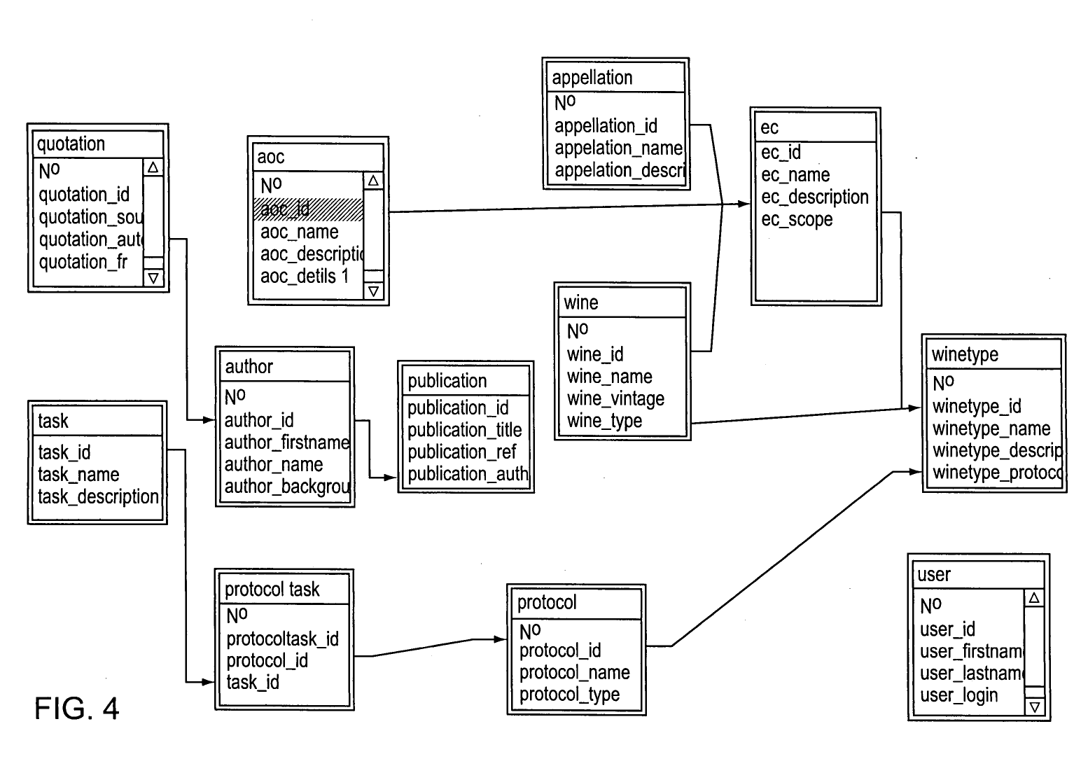

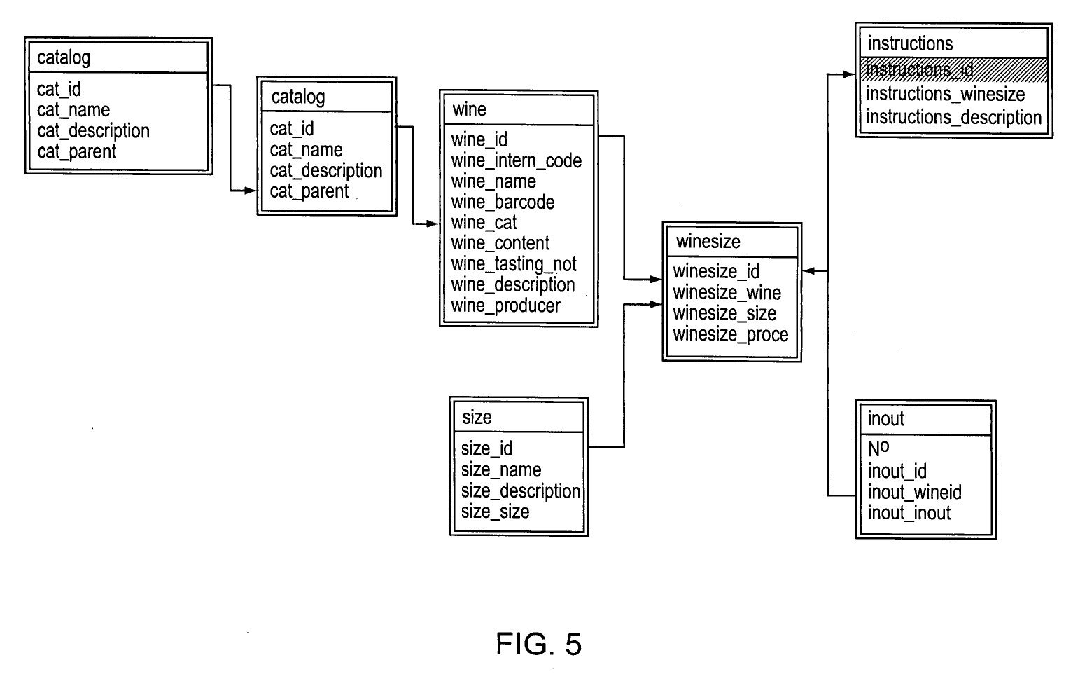

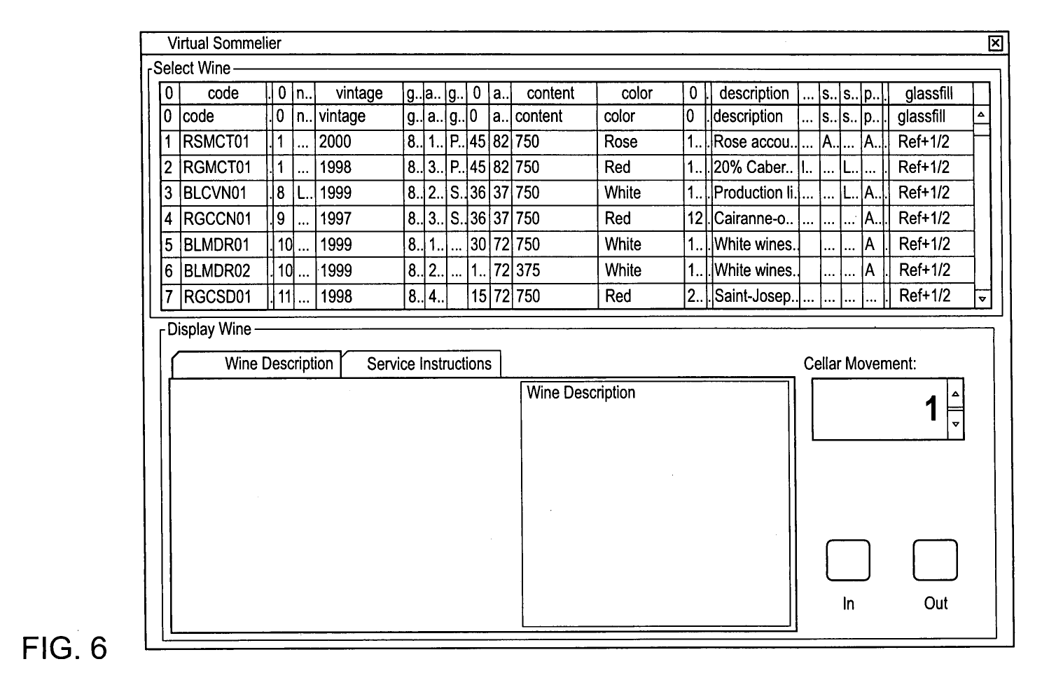

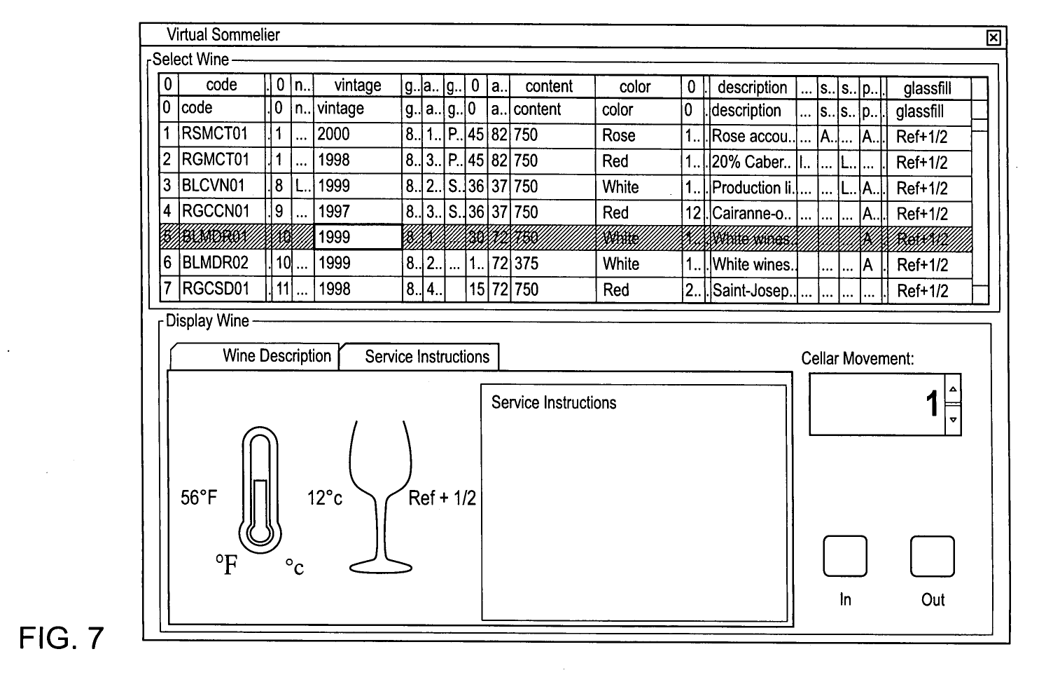

FIG. 4 shows an exemplary data structure within the VSRDB 120. FIG. 5 shows an exemplary data structure within the VSC 130. FIGS. 6 and 7 show an example of the VSC interface according to this exemplary embodiment.

The VSC 130 interface is accessible on the VSC 130 which can be, for example, physically located in the restaurant dining room. The VSC interface provides, for example, the information prepared by the restaurant manager for each wine on the wine list. The VSC interface can provide information related to wine description (FIG. 6) and wine service (FIG. 7).

The VSC 130 can be ergonomically designed to bring precise data in a minimum time frame, with a minimum of actions from the waiters 131. In a typical restaurant environment, waiters 131 have very little time to read lengthy information. Thus, the interface is easy to read and access data very fast. In a typical restaurant environment, waiters 131 also carry objects like bottles, towels, and plates and thus have difficulty using their hands to browse the wine list with a physical device like a computer mouse. Thus, the VCS 130 according to this exemplary embodiment has, for example, a touch screen with large buttons (to make interaction very simple) and a bar-code scanner (to retrieve wine info in seconds).

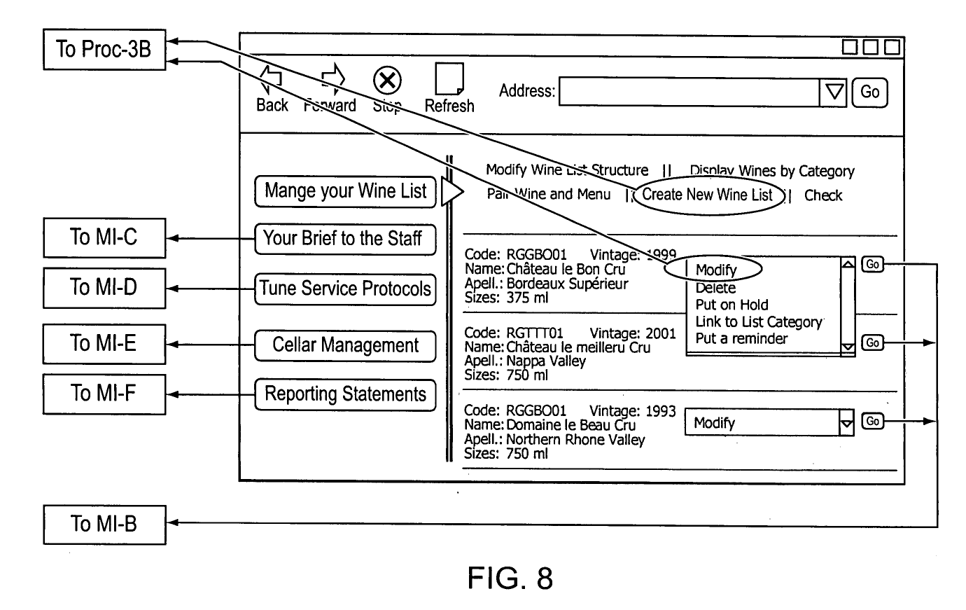

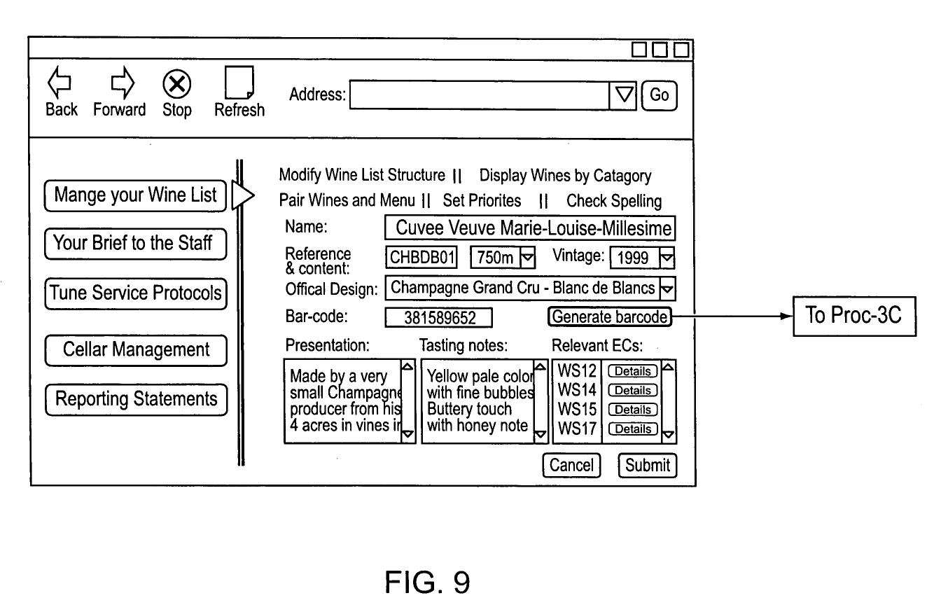

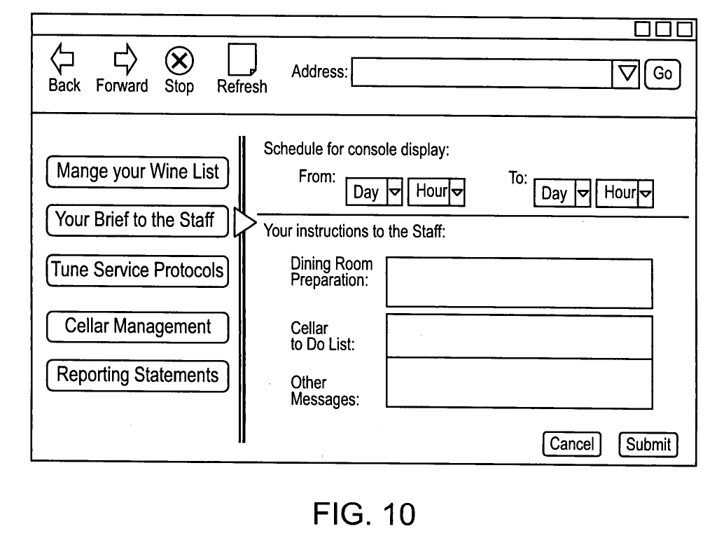

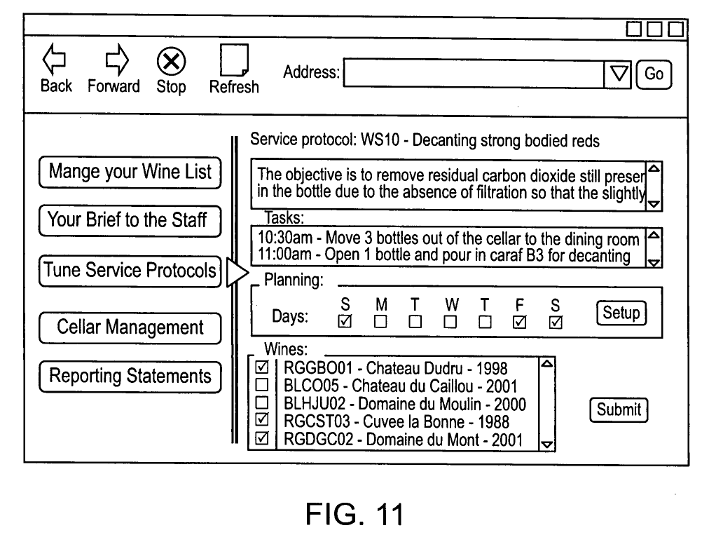

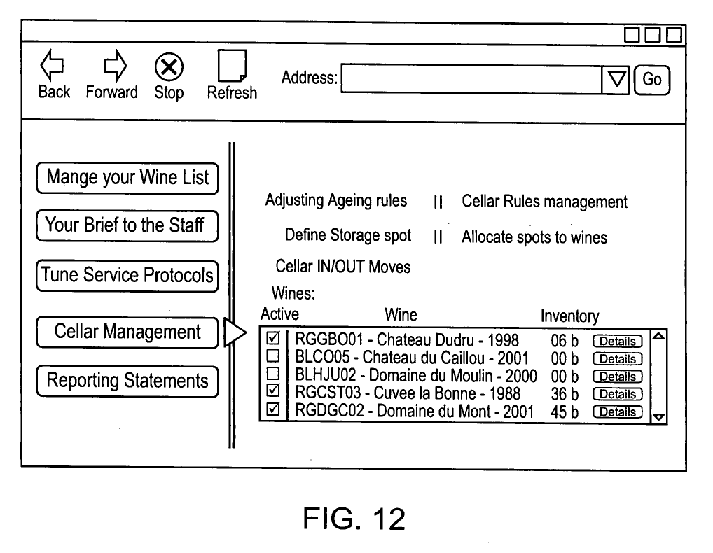

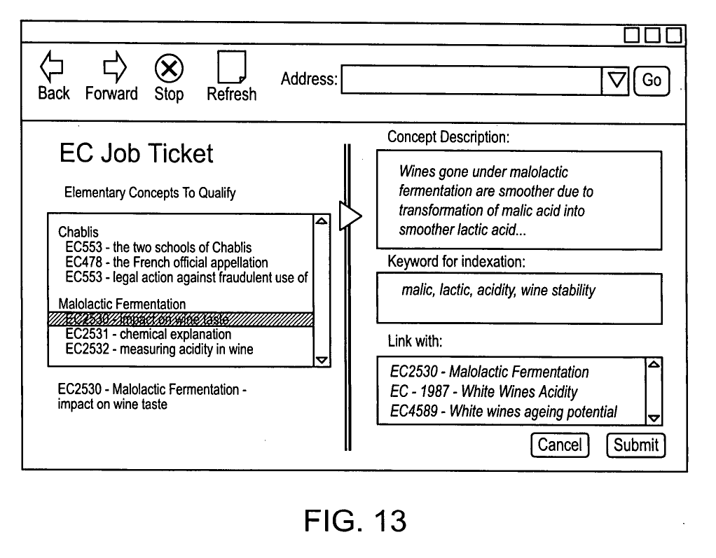

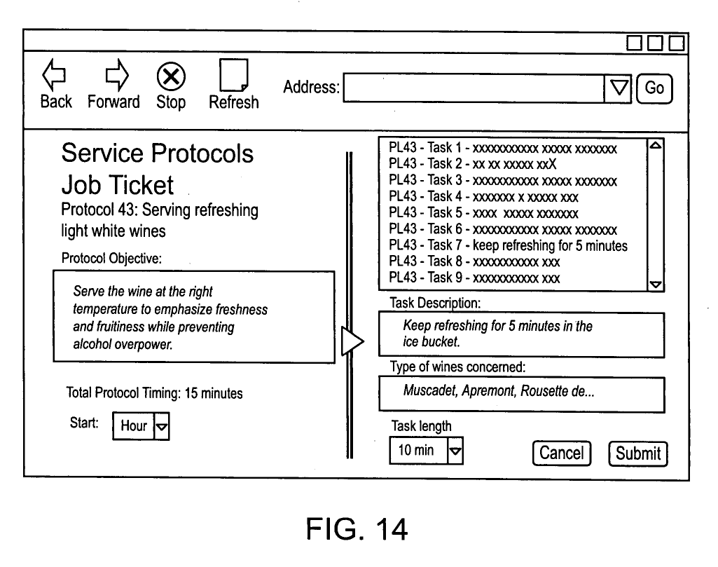

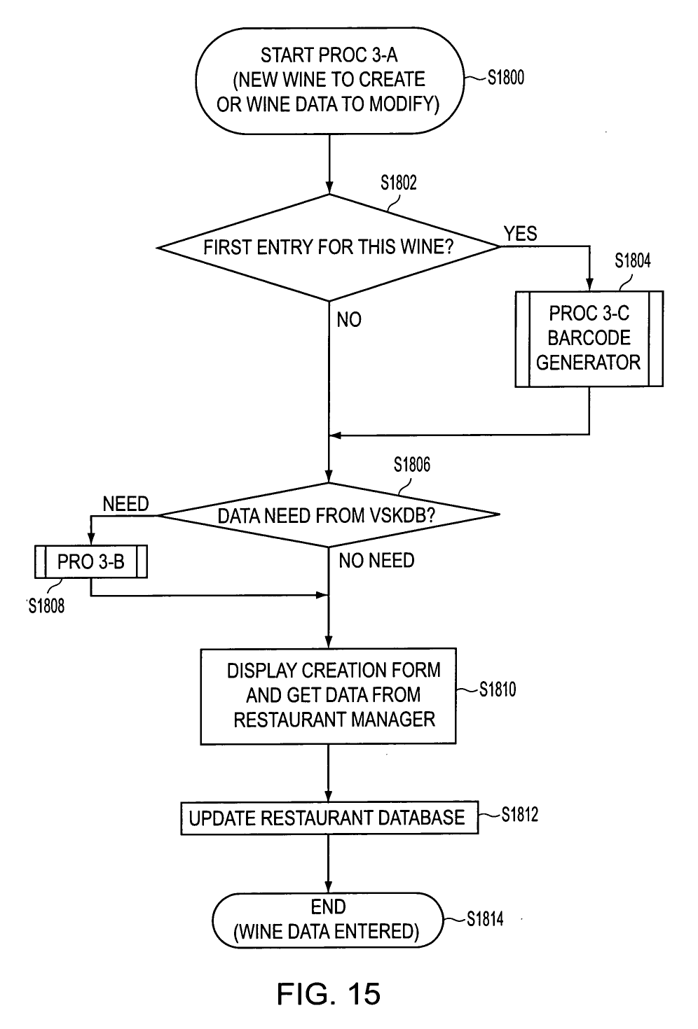

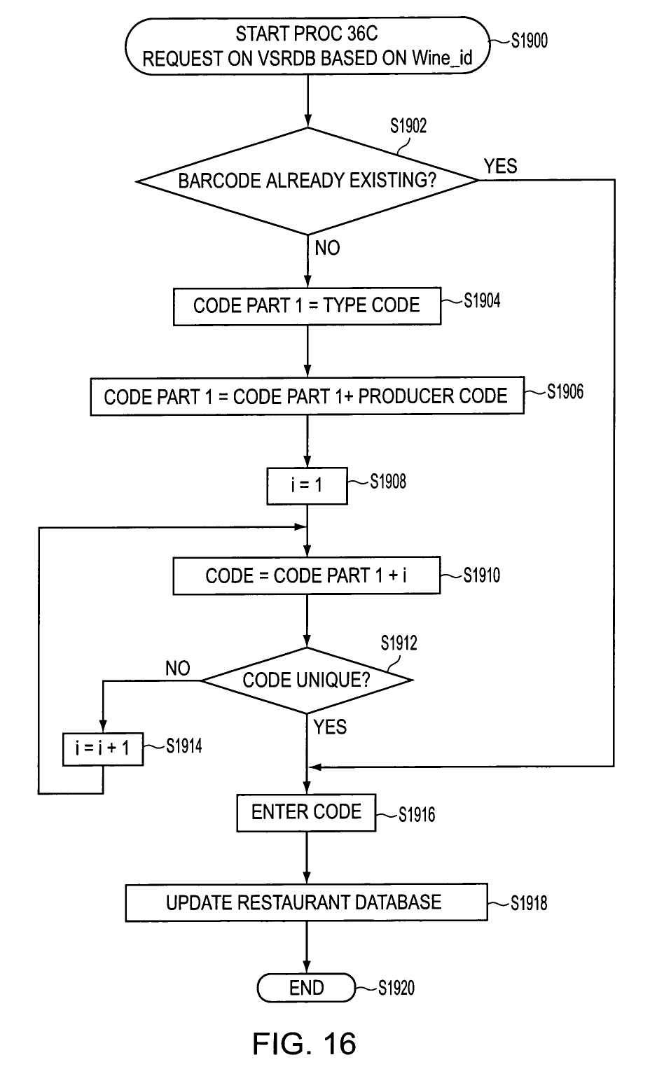

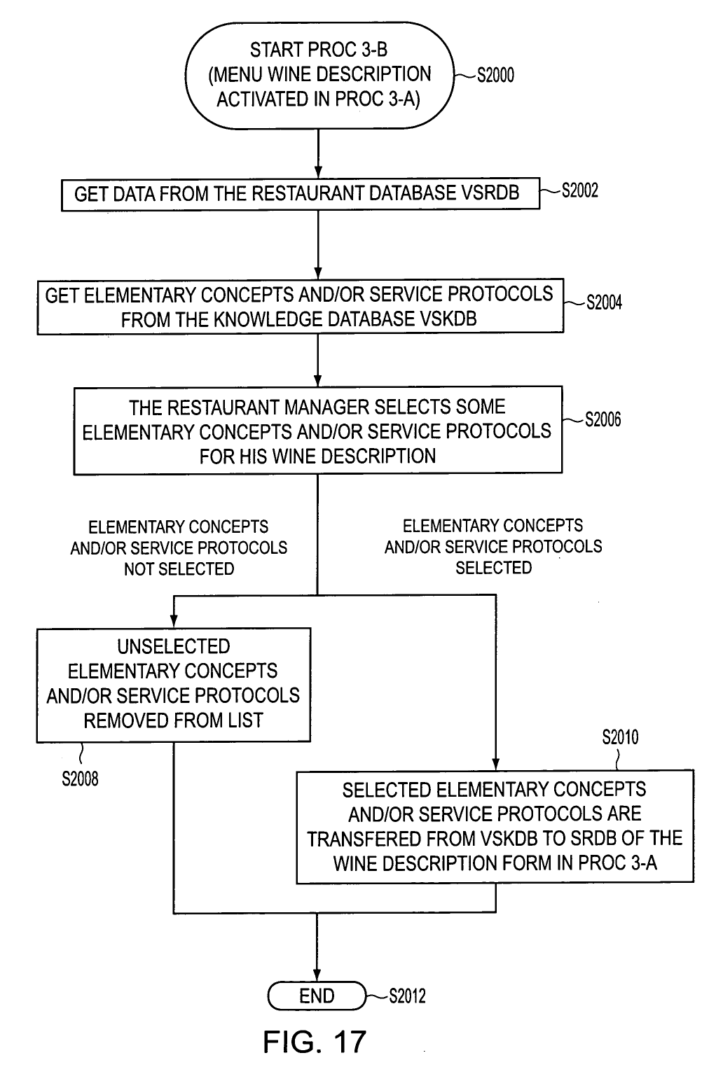

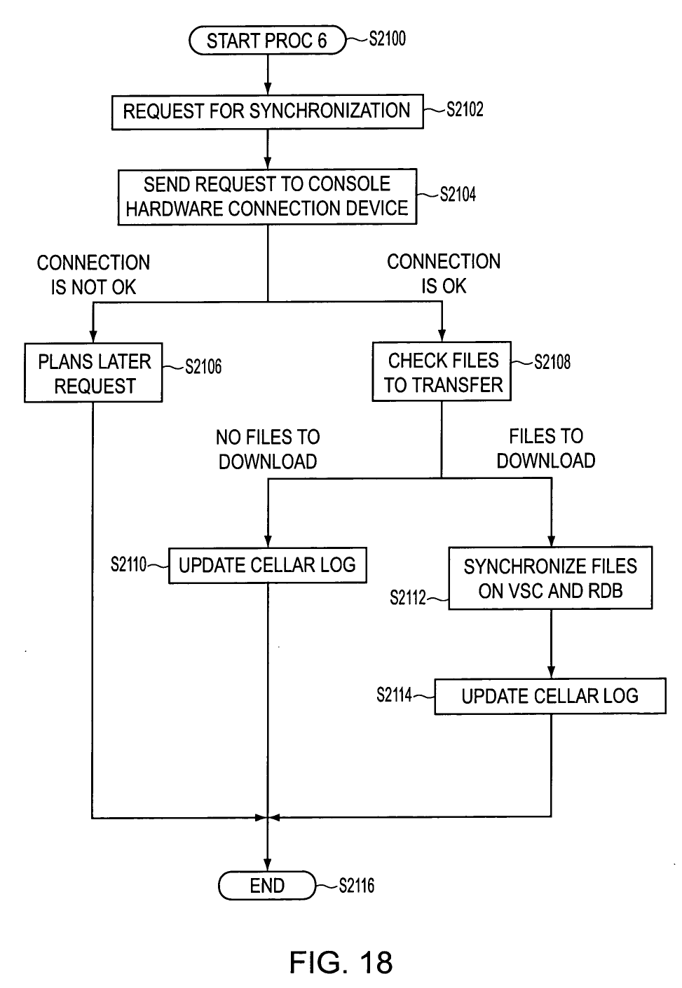

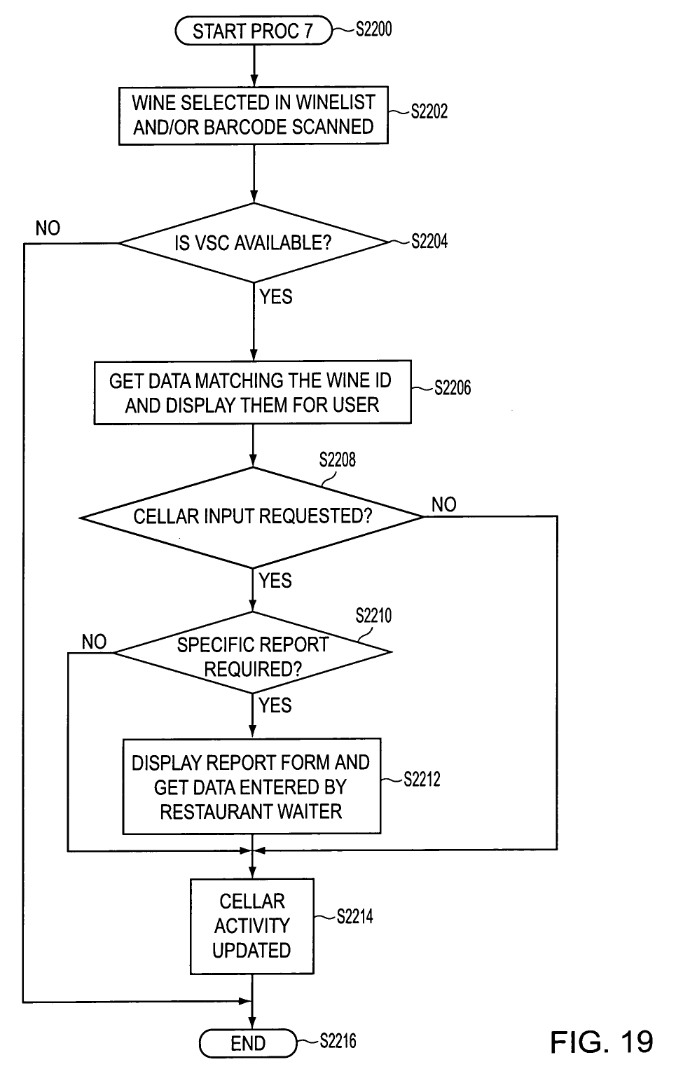

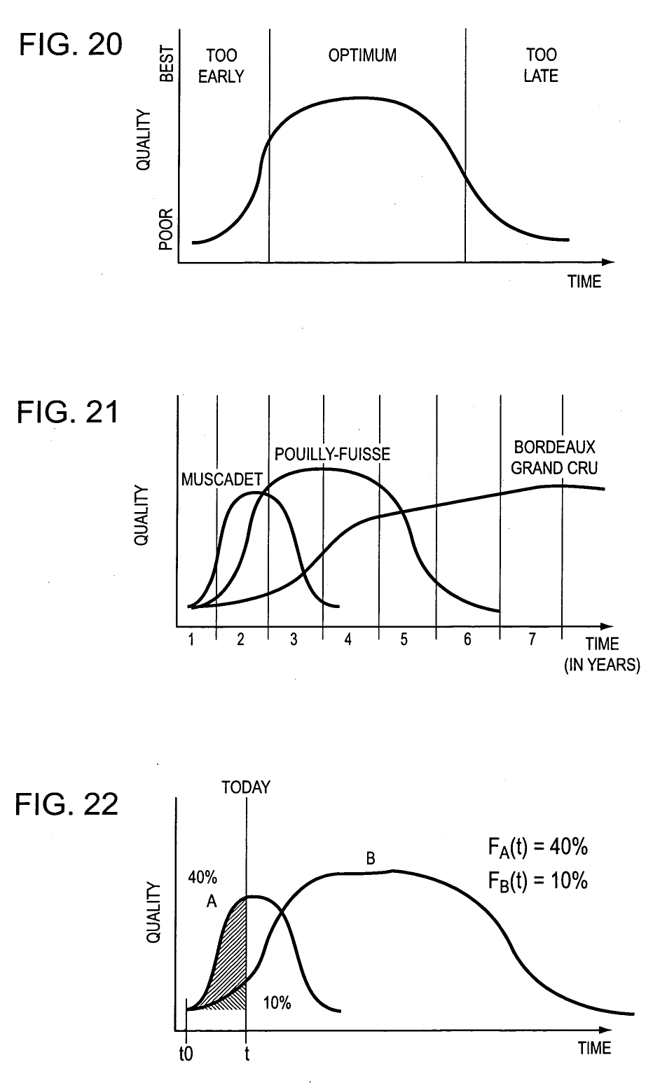

The manager 121 accesses the VSRDB 120 through, for example, a standard web browser. Once logged to the system, the manager 121 is, for instance, offered an interface with a general menu, as shown by the examples in FIGS. 8 to 12. The general menu, for example, allows the manager 121 to navigate through broad topics including, for example, a manage the wine list topic, a daily brief to the staff topic, a wine service protocols topic, a manage the cellar topic, and a reporting statements topic.

Experts 111 may access the system through, for example, a standard web browser, or any other commonly used or specifically designed network interface. Experts 111 have two major contributions to the VSKDB 110 management. They qualify Elementary Concepts through an Elementary Concept interface shown, for example, in FIG. 13. They also have to build and describe standard wine Service Protocols through a wine service protocol interface shown, for example, in FIG. 14.

Various processes that may be performed using the above-described system will be described with reference to FIGS. 15-19.

The first main process to consider is the population of the database with Elementary Concepts and other data. The task is performed by, for example, the administrator. The administrator, for example, installs the first program P1 and populates the different tables of the wine VSKDB 110 with information provided by the experts 111.

The second main process is the qualification and finding of data by experts 111. The Administrator, for example, sends to experts 111 the assignment to describe and to qualify Elementary Concepts. Each expert 111 receives job tickets (assignments) to work on specific data entered by the Administrator into the database. The job tickets concern a specific task to be performed by a specific expert. For example, a Sommelier may be appointed to describe EC number 2750 concerning the impact of malolactic fermentation.

The last main process is run by a group of experts 111 and the administrator to link the data stored in the different tables together. For example, information regarding the grape variety Carignan could be linked to the name Pays d'Oc and official appellations referring to the Languedoc region since this grape variety is typical of this region. This step cross references and indexes each related Elementary Concept according the knowledge of Oenologists and Sommeliers (experts 111).

Next, a process is run by the system administrator to create the database structure (VSRDB 120) for a specific restaurant. For example, the administrator installs the second program P2. The installation of program P2 creates an empty database and allows the restaurant manager to use the program P2.

Once the VSRDB 120 is set up, the manager 121 can enter data. When the restaurant manager 121 introduces a new wine, he needs to enter data to characterize the wine and to link it with Elementary Concepts and/or Service Protocols. The wine description and the tasting notes are critical to help the waiter to present the wine to the customer. An example of this process is shown in FIGS. 15-17.

FIG. 15 shows an exemplary method for entering new wine data or updating wine data in the VSRDB 120. Such wine data may include for example, name, vintage, appellation, content, and/or color. As shown in FIG. 15, operation of the method begins in step S1800. Next, in step S1802 it is determined whether the wine to be entered/modified has been previously entered in the VSRDB 120. If the wine is new, operation continues to step S1804. If the wine has been entered, operation jumps to step 1806. In step S1804 a unique code for the new wine is returned by the exemplary method of FIG. 16. Operation continues to sep S1806.

In step S1806, it is determined whether wine data is needed for the wine to be entered/modified from the wine knowledge database VSKDB 110. If wine data is needed operation continues to step S1808. If wine data is not needed, operation jumps to step S1810. In step S1808, wine data is obtained by the exemplary method of FIG. 17. After wine data is obtained in step S1808, operation continues to step S1810.

In step S1810, a creation/update form is displayed which allows the manager 121 to enter data regarding the wine. This data may be data retrieved from the VSKDB 110 in step S1808 or data entered by the manager 121. Then, in step S1812, the restaurant database VSRDB 120 is updated to include the information entered in step 1810.

FIG. 16 shows an exemplary method for determining a unique code for a certain wine. As shown in FIG. 16, the method begins in step S1900. Then, in step S1902, it is determined whether an identifying code exists on the VSRDB 120 for the wine to be entered/modified. If a bar-code was already given to the product either by the producer or any of the actors involved in the wine distribution (EAN, UPC, . . . ), an identifying code exists and operation jumps to step S1918. If a code is not found, the code must be created and operation continues to step S1904.

In step S1904, a variable code (CODE PART 1) is set with a type code representing the type of wine. For example, the type code may be a two letter color code such as “RG” for red wine, “BL for white wine, and “RS” for rose wine. Additionally, the type code may be based on another characteristic of the wine, for example, “SK” for sparkling wine and “SW” for sweet wine. Then, in step S1906, a wine producer code is added to the variable code. The wine producer code uniquely identifies the wine's producer and may be set according to the phonetics of the producer's name. For example, if the wine producer's name is “Domaine Lambda,” a three letter code such as “DLA” may be used as long as the code is not already used for another producer. Operation continues to step S1908. In step S1908, a variable i is set equal to 1. Then, in step S1910, the variable i is added to the variable code. In step S1912, it is determined whether the variable code, for example “RGDLA1,” is unique. If the variable code is unique, operation jumps to step S1918. If the code is not unique, operation continues to step S1914. In step S1914 the variable i is increased in value by, for example 1, and operation returns to step S1908.

In step S1916, the already existing code or created code is entered into the database either manually, or automatically. In step S1918 the VSRDB 120 is updated to reflect either the existing code or the created unique code. This code is now capable of being scanned at the console 130 as an identifier so that a waiter 131 can retrieve the information relevant to the corresponding wine immediately. If the code was a preexisting bar-code, it will likely already be printed on the bottle. If the code was created in steps S1904-S1912, then the code will likely have to be printed and affixed to the corresponding bottles. In step S1920, operation of the method ends.

FIG. 17 shows an exemplary method for obtaining wine information from the VSKDB 110. As shown in FIG. 17, operation of the method begins in step S2000. Then, in step S2002, data regarding the wine to be entered/updated is transmitted from the VSRDB 120 to the VSKDB 110. In step S2004, Elementary Concepts and/or Service Protocols related to the wine are retrieved using, for example key words, that might help the restaurant manager 121 to write relevant descriptions and use potentially appropriate tasks for the Service Protocols concerning this particular wine. Such Elementary Concepts are selected based on criteria including, for example, the name of the wine, the appellation, the grapes, the color, the vintage, etc. The retrieved Elementary Concepts and/or Service Protocols may include, for example the following.

1. EC1—Vintage 2000 as very hot in the Southern Rhone Valley. Generally red wines show higher concentration that usually. Rated between 89 and 92 by various wine critics.

2. EC2—The appellation Gigondas produces big red from Grenache, Mourvedre, and Syrah. The wines are ideally enjoyed between 3 and 8 years. Some like them young to get the more intensive fruity flavors. They will often show some rusticity though due to unripe tannins.

3. EC3—Gigondas is considered as the second most famous appellation of the Southern Rhone Valley after Chateauneuf du Pape. Its fame started shortly a long time after the official AOC sanction. It became popular in the US when the demand for Chateauneuf pushed the Chateauneuf prices dramatically up after the sumptuous vintages of 1998, 1999 and 2000.

4. EC 4—The following Domaines are regarded as the most influential for the appellation, not only because of the quality of their production but also because of their very particular style which arise as standards for other producers: Domaine des petits Ecrus, Domaine de la Ranjarde, Cave des Vignerons de la Font Becuse, etc.

5. Service Protocol: “decanting recommended—see protocol 45 and protocol 53”.

Next, in step S2006, the manager 121 selects from the retrieved Elementary Concepts and/or Service Protocols that he wishes to use in the wine description. In step S2008, the Elementary Concepts and/or Service Protocols that are not selected are removed from the Elementary Concepts and/or Service Protocols that will be used in the wine description. In step S2010, the Elementary Concepts and/or Service Protocols selected by the manager 121 are transferred from the VSKDB 110 to the VSRDB 120 to be used in the wine description.

The third program P3 is installed on the VSC 130 hardware by the system administrator. Once the VSRDB 120 is populated by the restaurant manager 121 a connection is made between the VSRDB 120 and the VSC 130 over, for example a network such as the Internet or an intranet so that appropriate data may be transferred by program P2 and program P3 to the VSC 130.

The VSC 130 connects to the VSRDB 120 on a regular basis to check if updates are required. The update process, for example, is launched automatically at a predetermined time or at the waiter's 131 demand.

An exemplary method for synchronizing data between the VSRDB 120 and the VSC 130 is shown in FIG. 18. As shown in FIG. 18, operation of the method starts in step S2100. Then, in step S2102, a request for synchronization is made. As mentioned above, this request may be made by a server 131 or may be automatic. In step S2104, a request for connection is sent from the VSRDB 120 to the VSC 130. If the connection between the VSRDB 120 and the VSC 130 is acceptable, operation jumps to step S2108. If the connection between the VSRDB 120 and the VSC 130 is not acceptable, the VSRDB 120 schedules a later request for synchronization (step S2102).

In step S2108, for example, the third program P3 checks if new files are available on the VSRDB 120. These files would have been prepared by the second program P2 beforehand, for example by the exemplary methods shown in FIGS. 15-17. If new files are available, operation jumps to step S2112. If no new files are available, operation continues to step S2110.

In step 2110, the third program P3 uploads data to the VSRDB 120 regarding cellar activity. In step S2112, the third program P3 downloads files to be updated on the console (VSRDB 120→VSC 130). Then, in step S2114 the third program P3 uploads data regarding the cellar activity (VSC 130→VSRDB 120) Finally, in step S2116, operation of the method ends.

An exemplary method for operating the VSC 130 is shown in FIG. 19. As shown in FIG. 19, operation begins in step S2200. Then, in step S2202, a wine is selected either by the bar-code scan or by the action of the waiter 131 selecting a wine from the wine list through the interface. Next, in step S2204 it is determined if the VSC 130 is available. For instance If the VSC 130 is currently being synchronized, as described above, it may not be available for use. If the VSC 130 is available, operation continues to step S2206. If the VSC 130 is not available, operation jumps to step S2216.

In step S2206, a set of data corresponding to the wine is displayed on the VSC 130 monitor so that the waiter 131 can read it. In step S2208, it is determined if the cellar activity needs to be updated by the waiter 131. If the cellar data does not need to be updated, operation jumps to step S2214. If the cellar activity needs to be updated, operation continues to step S2210. In step S2210, it is determined whether a specific report is required to update the cellar. A specific report is required if, for example, a bottle is entered or removed from the cellar or if the waiter 131 needs to report an event to the manager 121 (like a bottle corked for example).

If no specific report is necessary, operation jumps to step S2214. If a specific report is necessary, operation continues to step S2212. In step S2212, a report form is displayed on the VSC 130 and the waiter inputs specific data. The waiter 131 may enter data corresponding to an inventory adjustment (quantity, wine reference, In or Out move). The waiter 131 may also enter data regarding feedback. The VSC 130 may receive the waiter's 131 report by for example typing or by voice recognition. Operation continues to step S2214. In step S2214, the cellar activity is updated on the VSRDB 120. Then, in step S2216, operation of the method ends.

According to this exemplary embodiment of the invention, ageing information may be provided, for example by the VSC 130, to help the waiters 131 to make decision on which wine to suggest. The ageing information also helps the manager 121 protect the financial value of cellar inventory by avoiding spoilage due to over-ageing.

Time significantly influences the color, the smell, and the taste of wine. Planning wine ageing in the cellar is a critical task in order to serve the wine at an optimum maturity. If a wine is served too early, the wine is closed and sometimes shows harsh notes (like rough tannins) If a wine is served too late, the wine is declining and may be spoiled. Some wine experts 111 like to represent the ageing process as in a bell shape diagram called an “ageing curve,” for example shown in FIGS. 20-22.

Wines age differently depending on vintages, winemaking, grapes varieties, etc. Based on technical and tasting analysis, wine ageing potential is estimated by experts 111, such as sommeliers who are familiar with the ageing potential of wines.

As shown by FIG. 21, based on this approach a sommelier might rather serve a wine at its peak 1 to 2 years for a Muscadet, 1 to 3 years for a Pouilly-Fuisse, 5 to over 15 years for a Bordeaux Grand Cru. In a similar approach, this exemplary embodiment lets the restaurant manager 121 or a wine expert 111 adjust an ageing curve to each wine served in the restaurant. Then, for example, the curve is computed as mathematical expression so that the total area under the curves equals 1.

With reference to FIG. 22, the curve may then be used to determine a “priority coefficient” for service, computed as the area located under the curve and limited by a “today line.” The restaurant manager 121 can then easily set up preferences for wine service depending on vintage and ageing potential. With a coefficient between 25% and 75% of the ageing potential the wine will be perfect for service. The priority coefficient for service is a convenient tool to help the restaurant manager 121 to protect inventory by avoiding wine spoilage due to over-ageging. It also helps the waiters 131 to make a decision when several wines would be suitable.

Each wine coefficient is computed by the system at a precise “t” time, for example the time at which the wine will be served. The wine coefficient, fᵢ(t) then represents the percent of aging that has occurred relative to the quality of the wine. In the example shown in FIG. 22, f_{A}(t)>f_{B}(t). Thus, the restaurant waiter 131 should suggest to a customer to choose wine A instead of wine B. Based on the priority coefficient curve, the waiter 131 is provided a very simple visual sign on the VS Console to identify which wines would be best to suggest. The list could be ranked according to the priority coefficient. Another way to make the coefficient easy to visualize would be to use different colors: yellow when too young, pale green to deep green when perfect and red when almost over-aged (top priority for a coefficient over 70% since the restaurant manager 121 wants to get rid of the bottles before they turn bad).

Thus, according to this exemplary embodiment, the wine inventory can be managed at the first operating level (VSKDB 110), storing ageing curves in relation to the respective alcoholic beverage. At the second operating level (VSRDB 120), at time (t) of final representation spent from origin time (to) at which each alcoholic beverage was made, determining quality levels for the respective alcoholic beverage of the inventory, by computing for each alcoholic beverage the total area under the ageing curve, computing the partial area under same ageing curve between (to) and (t), and dividing the partial area by the total area to obtain a quality coefficient. At the third operating level (VSC 130), displaying and grading said quality levels, so that prioritization in the alcoholic beverage final dispensation is obtained.

It should be appreciated that although this exemplary embodiment has been described wherein the Internet is the network that links the various servers and terminals described above, any one or more networks such as, a wired or wireless network, an intranet, an extranet, a local area network, a wide area network, a storage area network, the Internet (especially the World Wide Web), and the like, may be used. In general, the data source network that connects the various can be any known or later-developed link that is capable of connecting servers and or terminals.

While various features of this invention have been described in conjunction with the exemplary embodiments outlined above, various alternatives, modifications, variations, and/or improvements of those features may be possible. Accordingly, the exemplary embodiments of the invention, as set forth above, are intended to be illustrative. Various changes may be made without departing from the spirit and scope of the invention.

What is claimed is:

1. A method for managing alcoholic beverages, comprising:
collecting, at a first operating level, knowledge from experts about a plurality of alcoholic beverages, including their respective service protocols;
storing, at the first operating level, the collected knowledge into a first memory;
collecting, at a second operating level, information from a manager including data specific to at least one retail outlet;
storing, at a second operating level, the collected information into a second memory;
exchanging, at the second operating level, information with the first operating level;
issuing, at the second operating level, at least one alcoholic beverage list with at least part of the collected knowledge and at least part of the collected information, each of the at least part of the collected knowledge and the at least part of the collected information respectively specific to various alcoholic beverages on the alcoholic beverage list;
retailing, at a third operating level, at least one of the various alcoholic beverages on the alcoholic beverage list;
exchanging, at the third operating level, information with the second operating level;
displaying, at the third operating level, based on the information exchanged with the second operating level, at least part of the at least part of the collected knowledge and at least part of the at least part of the collected information; and
reporting at the third operating level, information related to the retailing of the at least one of the various alcoholic beverages on the alcoholic beverage list.

2. The method according to claim 1, wherein the alcoholic beverages are wines.

3. The method according to claim 2, wherein the knowledge collected from the experts comprises knowledge related to at least one of:
appellations and/or service protocols;
wine ageing for instance ageing curves;
academic knowledge about wine;
testing notes or quotations; and
vintage charts.

4. The method according to claim 2, wherein the information collected from the manager comprises at least one of:
data regarding an inventory report; and
cellar activity.

5. The method according to claim 2, wherein the at least part of the at least part of the collected knowledge and the at least part of the at least part of the collected information displayed at the third operating level comprises at least one of:
management directives; and
instructions on wine service and presentation.

6. The method according to claim 2, wherein the data specific to the at least one retail outlet comprises data related to the cellar activity.

7. The method according to claim 2, wherein issuing, at the second operating level, at least one alcoholic beverage list with at least part of the collected knowledge and at least part of the collected information comprises issuing at least one of:
working instructions;
dispensation protocols; and
service instructions.

8. The method according to claim 1, wherein the collected knowledge is divided into elementary concepts and the elementary concepts are indexed by key words.

9. The method according to claim 1, further comprising:
storing, at the first operating level, ageing curves related to the plurality of alcoholic beverages;
determining, at the second operating level, at a predefined time measured from an origin time at which an alcoholic beverage on the alcoholic beverage list was made, a quality level for that alcoholic beverage, by:
computing a total area under a stored ageing curve corresponding to that alcoholic beverage;
computing a partial area under the stored ageing curve corresponding to that alcoholic beverage between an origin time for that alcoholic beverage and the predefined time; and
dividing the computed partial area by the computed total area to obtain the quality level; and
grading the determined quality level, so that a retail priority is obtained; and
displaying, at the third operating level, the graded quality level.

10. An alcoholic beverage management system, comprising:
a first operating level, hosted on a networked server, accessible to experts, including:
a first database in which alcoholic beverage knowledge, including their respective service protocols, are indexed and stored; and
a first set of instructions for running the first database and communicating the first database with a network;
a second operating level, hosted on an networked server, accessible to managers, including:
a second database in which data specific to at least one retail outlet is stored; and
a second set of instructions for running the second database and exchanging information with the first database, in order to issue an alcoholic beverage list with at least a portion of the knowledge on the first database and at least a portion of the data on the second database specific to respective alcoholic beverages on the alcoholic beverage list, and make the alcoholic beverage list available to the network; and
a third operating level, hosted by a networked console, accessible to alcoholic beverage servers, comprising:
a third set of instructions for exchanging information with the second database, so as to display the at least a portion of the knowledge on the first database and the at least a portion of the data on the second database specific to the respective alcoholic beverages on the alcoholic beverage list, and to report to the second operating level information specific to retailing.

11. The system according to claim 10, comprising alcoholic beverage units, each unit comprising an identifying bar-code, wherein:
the third operating level further comprises a bar-code scanner, and
the third level of instructions comprises instructions for:
converting a digital signal read by the bar-code scanner into identifying data;
searching for, in the first database, through the second operating level, or at the third operating level, knowledge specific to the identifying data; and
displaying the searched for knowledge the console networked console.

12. The system according to claim 10, wherein the second set of instructions comprises instructions for:
exchanging data with the third operating level;
exchanging data with the first database; and
determining a current alcoholic beverage inventory.

13. A system according to claim 10, wherein the first set of instructions comprises instructions for:
entering data regarding alcoholic beverage knowledge from experts;
exchanging data regarding alcoholic beverage management with the second operating level; and
updating the first database.

14. A system according to claim 10 comprising instructions for synchronizing information between the first, second and third operating levels.

15. A system according to claim 14, wherein the instructions for synchronizing include instructions for data and file exchanges, between the first database, the second database, and with the console.

16. A method for managing alcoholic beverages, comprising:
collecting knowledge from experts about a plurality of alcoholic beverages, including their respective service protocols;
storing, the collected knowledge into a memory; and
providing the stored knowledge to at least one retail outlet, to be used to issue at least one alcoholic beverage list;
wherein the collected knowledge is stored as elementary concepts, the elementary concepts specifically tailored to be easily assembled to create the at least one alcoholic beverage list, and the at least one alcoholic beverage list includes at least a part of the collected knowledge.

17. A storage medium storing a set of program instructions executable on a data processing device and usable for managing alcoholic beverages, the set of program instructions comprising:
instructions for collecting knowledge from experts about a plurality of alcoholic beverages, including their respective service protocols;
instructions for storing, the collected knowledge into a memory; and
instructions for providing the stored knowledge to at least one retail outlet, to be used to issue at least one alcoholic beverage list;
wherein the collected knowledge is stored as elementary concepts, the elementary concepts specifically tailored to be easily assembled to create the at least one alcoholic beverage list, and the at least one alcoholic beverage list includes at least a part of the collected knowledge.

18. A method for managing alcoholic beverages, comprising:
collecting information from a manager including data specific to at least one retail outlet;
storing the collected information into a memory;
exchanging information with an electronic alcoholic beverage knowledge repository that is remote from the memory, the electronic alcoholic beverage knowledge repository storing elementary concepts specifically tailored to be easily assembled to create the at least one alcoholic beverage list; and
issuing, at least one alcoholic beverage list with at least part of the collected information and at least one elementary concept from the electronic alcoholic beverage knowledge repository.

19. A storage medium storing a set of program instructions executable on a data processing device and usable for managing alcoholic beverages, the set of program instructions comprising:
instructions for collecting information from a manager including data specific to at least one retail outlet;
instructions for storing the collected information into a memory;
instructions for exchanging information with an electronic alcoholic beverage knowledge repository that is remote from the memory, the electronic alcoholic beverage knowledge repository storing elementary concepts specifically tailored to be easily assembled to create the at least one alcoholic beverage list; and
instructions for issuing, at least one alcoholic beverage list with at least part of the collected information and at least one elementary concept from the electronic alcoholic beverage knowledge repository.

20. A method for managing alcoholic beverages, comprising:
retailing at least one alcoholic beverage on an alcoholic beverage list, the alcoholic beverage list including information from a manager including data specific to at least one retail outlet and at least one elementary concept specifically tailored to be easily assembled to create the at least one alcoholic beverage list, the at least one elementary concept obtained from a remote electronic alcoholic beverage knowledge repository;
exchanging information with a managing knowledge repository;
displaying, based on the information exchanged with the managing knowledge repository, at least part of the alcoholic beverage list; and
reporting to the managing knowledge repository information related to the retailing of the at least one alcoholic beverage on the alcoholic beverage list.

21. A storage medium storing a set of program instructions executable on a data processing device and usable for managing alcoholic beverages, the set of program instructions comprising:
instructions for retailing at least one alcoholic beverage on an alcoholic beverage list, the alcoholic beverage list including information from a manager including data specific to at least one retail outlet and at least one elementary concept specifically tailored to be easily assembled to create the at least one alcoholic beverage list, the at least one elementary concept obtained from a remote electronic alcoholic beverage knowledge repository;
instructions for exchanging information with a managing knowledge repository;
instructions for displaying, based on the information exchanged with the managing knowledge repository, at least part of the alcoholic beverage list; and
instructions for reporting to the managing knowledge repository information related to the retailing of the at least one alcoholic beverage on the alcoholic beverage list.
